(19) United States
(12) Patent Application Publication
(10) Pub. No.: US 2007/0068006 A1
(43) Pub. Date: Mar. 29, 2007

(54) Scissors having a depression to flush out the joint area

(76) Inventors: Uwe Schlichting, Wuppertal (DE); Schultz Erhardt, Solingen (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/506,484

(22) Filed: Aug. 18, 2006

(30) Foreign Application Priority Data
Aug. 18, 2005 (DE) 102005039529.5

(51) Int. Cl. B26B 13/00

(52) U.S. Cl. 30/254

(57) ABSTRACT

In order to clean hair clippings from the joint (2) of scissors (1), it is proposed that at least one scissor half (3, 4) be designed to have a depression (11) to flush out the joint (2), said depression ending in a slot (9) of the joint (2), wherein the depression (11) is enclosed by a pivot area (10), wherein the depression (11) is at least partially surrounded by a wall (12), and wherein the depression (11) has an outlet (14) for the cleaning agent to drain off (FIG. 1).

The object of this application relates to scissors, in particular for use in hair salons, and involves two scissor halves, pivotable about a joint, each scissor half having a blade with a cutting edge, as well as a gripping element, in particular a grip eye, wherein the joint is formed by a stud that protrudes through a slot in each scissor half in order to link the scissor halves, and wherein the scissor halves are positioned on top of one another with one pivot area each in the joint area.

Such scissors are well known. They have the disadvantage that they must be cleaned of hair clippings in the joint area from time to time in order to insure absolute ease of use over a long period of time. This cleaning must be done by a hairdresser or service personnel after the scissor halves have been separated from one another.

The object of the present invention is to develop scissors in such a manner as to allow a simple way of cleaning them in the joint area.

The object is achieved in that at least one scissor half has a depression, which ends in the slot and which serves to flush out the joint area. In this context, the depression is enclosed by the pivot area, and the depression is at least partially surrounded by a wall. The depression has an outlet. The depression can be flushed out with water. The outlet is designed to drain off or let in water. The water flushes hair clippings from the joint area and thereby cleans it. Thus, the joint is exposed to less friction during cleaning. The depression can be mill-cut from the respective scissor half, which is relatively economical. In order for water to better flow in or drain off, it is advantageous if the depression is designed to be at the back of the scissor half.

The advantageous flowing in and draining off of a cleaning agent is achieved when the facing sides of the joint are designed to each have a part of the depression. In this way, one part can be utilized as an inlet, and the other part can be used as an outlet to drain off the cleaning agent. An appropriate cleaning agent is running water from a tap. Scissor oil could also be used to flush out hair clippings. This would be a simple way to oil the joint at the same time.

The wall, which encloses the depression, can be completely closed when the entire depression or a part thereof serves as the inlet or outlet for the cleaning agent. Or, the wall does not have to completely surround the depression, but rather can have a gap that serves as the inlet or outlet.

The invention is described below with reference to Figures that show an exemplary embodiment. In the drawing:

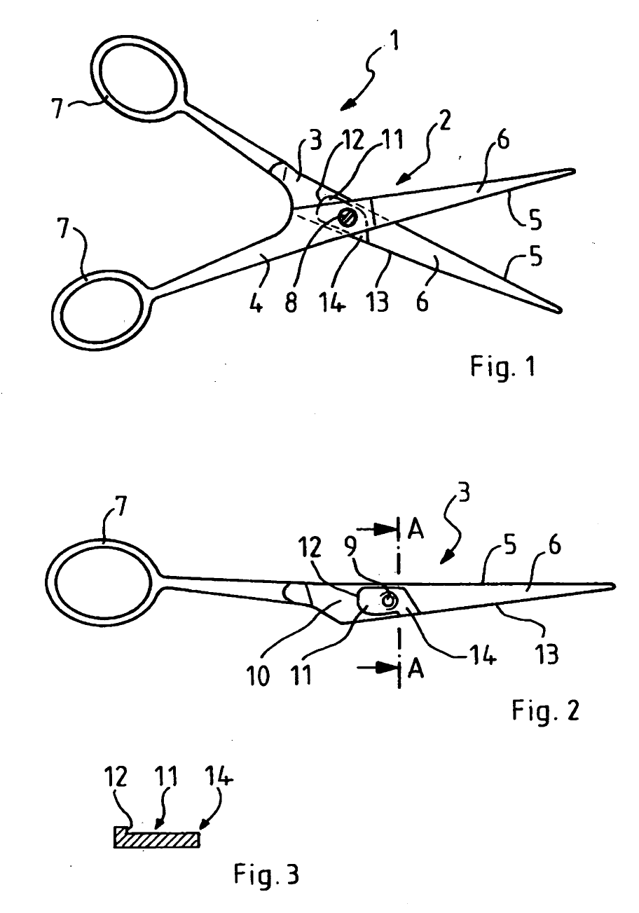

FIG. 1 opened scissors;

FIG. 2 a scissor half of FIG. 1, wherein a depression with an outlet surrounds a drilled slot of the scissor half;

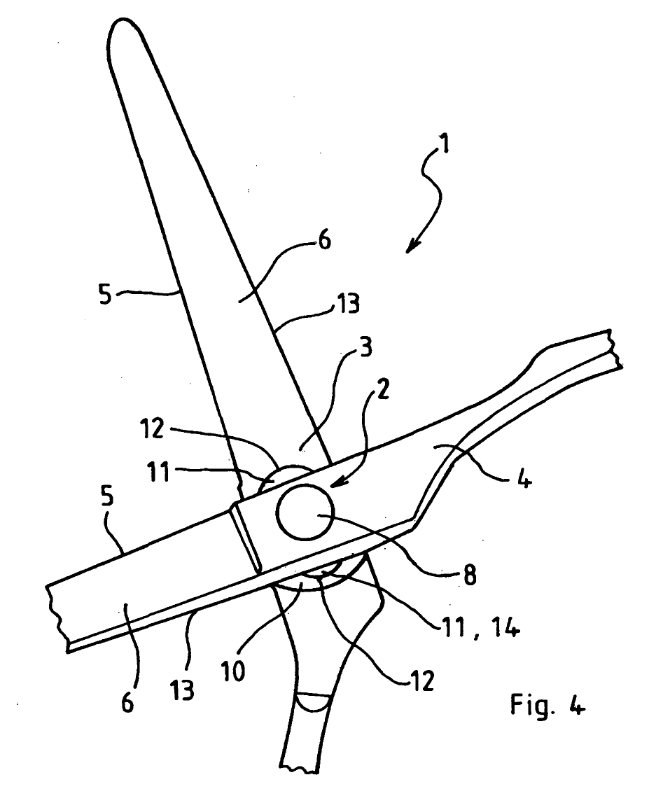

FIG. 3 the scissor half of FIG. 1 in a cross-section along line A-A of FIG. 2; and

FIG. 4 a joint area of opened scissors, wherein a depression at the joint is designed to be completely enclosed by a wall.

Scissors 1 for use in hair salons that feature two scissor halves 3, 4, pivotable about a joint 2 (FIGS. 1 to 3). Each scissor half 3, 4 is designed to have a blade 6 with a cutting edge 5, as well as a gripping element, which is designed as a grip eye 7 for each scissor half 3, 4. The joint 2 is formed by a stud 8 that protrudes through a slot 9 of the scissor halves 3, 4 in order to link the scissor halves 3, 4. The scissor halves 3, 4 are positioned on top of one another with one pivot area 10 each in the area of the joint 2. One scissor half 3 is designed to have a depression 11, which ends in the slot 9. The depression 11 is enclosed by the pivot area 10. The depression 11 is partially surrounded by the wall 12 and ends in an outlet. When the scissors are open, the planned depression 11 of the lower scissor half 3 and its outlet 14 protrude under the upper scissor half 4. In this state, water from a tap can be flushed into the depression 11. The water cleans the depression 11 of hair clippings deposited there and flushes these hair clippings from the outlet 14 that ends at the back 13 of the lower scissor half 3. The depression 11 serves to collect and remove the hair clippings.

In the exemplary embodiment of FIG. 4, a depression 11 is completely surrounded by a wall 12. Each of the facing sides of the joint 2 features a part of the depression 11. Hair clippings that collect in the area of the joint 2 between the scissor halves 3, 4 are collected in the depression 11 and can subsequently be flushed from the depression 11 using tap water. For this purpose, such scissors 1 are held under a stream of water so that one part of the depression 11 serves as an inlet, and the other part of the depression 11 serves as an outlet 14 for the water flowing through the depression 11.
1 Scissors
2 Joint
3, 4 Scissor half
5 Cutting edge
6 Blade
7 Grip eye
8 Stud
9 Slot
10 Pivot area
11 Depression
12 Wall
13 Back
14 Outlet

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Scissors for use in hair salons, comprising two scissor halves, said scissor halves being pivotable about a joint, and each scissor half comprising a blade with a cutting edge and a gripping element, wherein the joint is formed by a stud that protrudes through a slot of the scissor halves in order to link the scissor halves, and wherein the scissor halves are positioned on top of one another with one pivot area in the area of the joint, wherein at least one scissor half comprises a depression, which ends in a slot, wherein the depression is enclosed by the pivot area, wherein the depression is at least partially surrounded by a wall, and wherein the depression has an outlet.

2. Scissors according to claim 1, wherein the joint comprises facing sides, wherein the facing sides each comprise a part of the depression.

3. Scissors according to claim 1, wherein the wall completely surrounds the depression.

4. Scissors according to claim 1, wherein the wall comprises a gap.

5. Scissors according to claim 4, wherein the gap is at the back of the scissor blade.

6. Scissors according to claim 1, wherein the depression is mill-cut.
